(19) United States
(12) Patent Application Publication
(10) Pub. No.: US 2008/0005558 A1
(43) Pub. Date: Jan. 3, 2008

(54) Methods and apparatuses for authentication and validation of computer-processable communications

(75) Inventors: Mark D. Hadley, Kennewick, WA (US); Craig A. Goranson, Kennewick, WA (US); Kristy A. Huston, Richland, WA (US); Ross T. Guttromson, Richland, WA (US)

Correspondence Address: BATTELLE MEMORIAL INSTITUTE;ATTN: IP SERVICES, K1-53, P. O. BOX 999, RICHLAND, WA, 99352, US

(73) Assignee: Battelle Memorial Institute, Richland, WA (US)

(21) Appl. No.: 11/479,402

(22) Filed: Jun. 29, 2006

(51) Int. Cl. H04L 9/00

(52) U.S. Cl. 713/159

(57) ABSTRACT

Computer-processable communication authentication and validation methods and apparatuses are described according to various embodiments. In one embodiment, an authentication and validation method comprises encapsulating an untrusted payload with a header and an authenticator. The header can comprise a unique identifier and the authenticator can comprise at least a portion of a keyed-hash message authentication (HMAC) value based on the content of the header, the content of the payload, and a unique key maintained for each of one or more receiving devices.

### STATEMENT REGARDING FEDERALLY SPONSORED RESEARCH OR DEVELOPMENT

This invention was made with Government support under Contract DE-AC05-76RL01830 awarded by the U.S. Department of Energy. The Government has certain rights in the invention.

### BACKGROUND

A number of critical infrastructure environments employ computer-processable communication protocols that should not be trusted because they are very vulnerable to cyber attack. Examples include some supervisory control and data acquisition (SCADA) systems, which can be found, among others, in a variety of process control environments (e.g., electric, gas, oil, water, and waste water utilities). These computer-processable communication protocols can be subject to attack because they typically send data in a clear text format, are usually unauthenticated, the communication media is subject to compromise, and/or the distance between nodes can be very large (e.g., hundreds of miles). Therefore, attackers can have ample opportunity to read, replay or modify, and send data in an unauthorized manner.

While encryption of the payload could address these vulnerabilities, in many instances, the equipment supporting communications in these environments comprises legacy hardware that would have to be upgraded, making encryption cost-prohibitive. However, even in instances where a level of encryption is implemented, it may not be sufficient given the environment in which the communications occur. Therefore, a need exists for efficient methods and apparatuses for authenticating and validating computer-processable communications comprising untrusted payloads.

### DESCRIPTION OF DRAWINGS

Embodiments of the invention are described below with reference to the following accompanying drawings.

FIG. 1. A diagram of an embodiment of a frame structure according to at least some aspects of present invention.

FIG. 2. An illustration depicting a specific frame structure according to one embodiment of the present invention.

FIG. 3. A block diagram depicting an apparatus for authentication and validation of computer-processable communications according to one embodiment of the present invention.

FIG. 4. An illustration of an exemplary system utilizing authenticated and validated computer-processable communications according to one embodiment of the present invention.

FIG. 5. A flow chart depicting one embodiment of a secure operations taxonomy.

### DETAILED DESCRIPTION

At least some aspects of the disclosure provide apparatuses and computer-implemented methods for authenticating and validating computer-processable communications that comprise untrusted payloads. Exemplary authentication and validation can comprise encapsulation of the payload with a header and an authenticator, wherein the header comprises a unique identifier and the authenticator comprises at least a portion of a keyed-hash message authentication (HMAC) value based on the content of the header, the content of the payload, and a unique key maintained for each of one or more receiving devices. In some embodiments, encapsulation of the payload leaves the payload unmodified. Accordingly, the encapsulation can be viewed as an additional layer of security that does not interfere with encrypted or non-encrypted payloads.

According to some embodiments, the computer-processable communication having an encapsulated payload can be transmitted from a sending device to one or more receiving devices, which each recalculate the authenticator according to the device's unique key. The recalculated authenticator can then be compared to the original authenticator received with the communication. Discrepancies between the recalculated and the original authenticator values can indicate that the communication did not originate from the expected source and/or that it has been tampered with or replayed.

Untrusted, as used herein, can refer to communications that lack, or have insufficient measures for, authentication, encryption, and/or validation.

As used herein, computer-processable communications can refer to information-containing transmissions between two or more devices, which transmissions are arranged according to a frame structure having an untrusted payload. In some embodiments, the computer-processable communication can be serial. The computer-processable communications can be implemented, for example, in environments and/or according to protocols including, but not limited to, supervisory control and data acquisition (SCADA), control systems, process controls, DNS, network time protocol (NTP), VoIP, automated meter reading, streaming data, satellite communication, GPS, sensor networks, automated toll systems, serial line interface protocol (SLIP), point-to-point protocol (PPP), and instant messaging protocols.

Exemplary contexts in which such computer-processable communications can exist include, but are not limited to SCADA systems, distributed control systems (DCS), energy management systems (EMS), process control systems, telecom systems, and network management systems, especially as utilized by critical infrastructure sectors (e.g., agriculture, food, water, public health, emergency services, government, defense industrial, information and telecommunications, energy, transportation, banking and finance, chemical industry, and postal and shipping). In a specific embodiment, computer-processable communication comprises clear text, high-availability transmissions by legacy and/or low-bandwidth hardware, which can often exist for real-time (or near real-time) process control operations, remote sensors, GPS transmissions, text messaging, combat fire-control systems, etc. In one embodiment, low-bandwidth rates are less than or equal to approximately 512 kbps. In another embodiment, low-bandwidth rates are less than or equal to approximately 115 kbps.

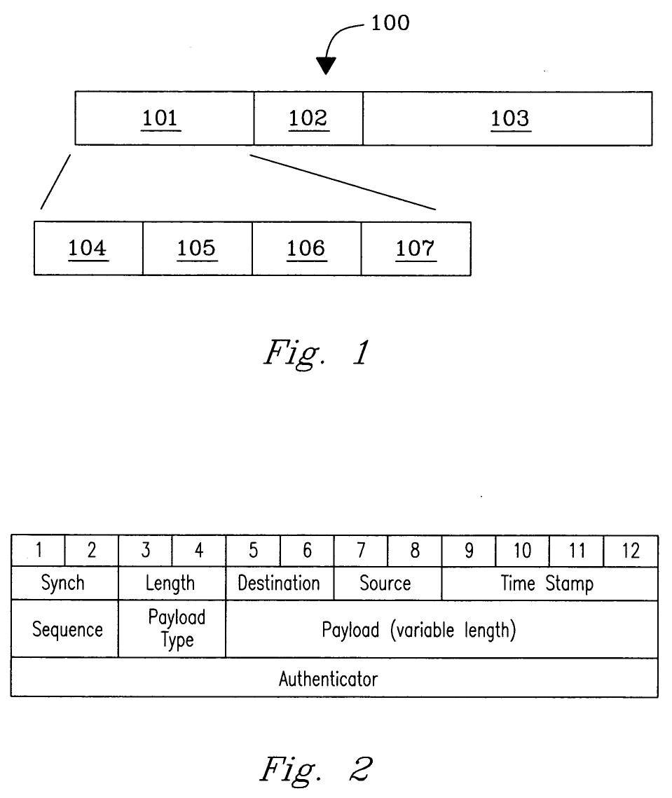

The illustration in FIG. 1 depicts one embodiment of a frame structure 100 according to which computer-processable communications can be structured. An initially untrusted payload 102 is encapsulated by a header 101 and an authenticator 103. The payload 102 can be either variable or fixed in length. The authenticator 103 can be a truncated HMAC value, which HMAC value is calculated based on the content of the header 101, the content of the payload 102, and a device's unique key. A truncated HMAC value is sometimes used to minimize the additional latency associated with the encapsulation. However, for added security the authenticator can comprise up to the entire HMAC value.

The header 101 can further comprise a synchronization field 104, a message length field 105, a timestamp field 107, and a sequence number field 108. In certain implementations, the inclusion of the authenticator and the header has a minimal impact on the timeliness of the protocol of the computer-processable communications. In other words, the added latency is minimal. Accordingly, in some embodiments, the header and the authenticator encapsulating the original payload total 24 or fewer bytes.

The synchronization field 104 denotes the beginning of the packet while the length field 105 specifies the length in bytes of the entire packet excluding the synch and length fields. The timestamp field 106 adds the time, date, or both to the packet. The sequence field 107 is included in every packet and the value must be different (e.g., incremented) for each packet sent, thereby providing each packet with at least part of the unique identifier. In some embodiments, the timestamp value can be combined with the sequence number to compose the unique identifier. The sequence field value should not rollover and can be reset upon successful key exchanges.

### Example: Embodiment of a Frame Structure

Referring to FIG. 2, the illustration depicts one embodiment of a frame structure and shows, as an example, field offsets in bytes. For illustrative purposes, specific values are described for byte offsets and field values, but other values are possible. The synchronization field, the length field, the destination field, the source field, and the sequence field are each 2 bytes long. The destination field specifies the packet's recipient while the source field specifies the packet's origin. The 4-byte timestamp field comprises a UNIX timestamp.

The payload is preceded by a one-byte payload type field, which specifies the type and contents of the payload for the packet. Exemplary types of payloads and their payload type field values can include, but are not limited to, regular data (e.g., 0x01), key exchange communications (e.g., 0x02), health check requests (e.g., 0x04), and health check responses (e.g., 0x05). The payload follows the payload type field and can contain variable length data consistent with the payload type. The key, as used herein, is used to calculate the HMAC, and can be symmetric.

An exemplary health check payload format, for requests or responses, can comprise a two-byte health check value. A master can request a health check by sending a randomly generated unsigned health check value. The slave can then respond by sending the value back incremented by one. Rollover is acceptable for the health check value.

An exemplary payload format for key exchange communications can comprise a key update type field and a key exchange data field. The key update type field can specify the type of key exchange being requested. Types of key exchanges can include, but are not limited to, Diffie-Hellman (DH) and pre-shared table index. The key exchange data field can comprise key exchange data of variable length.

For DH key exchanges, the key exchange data field can comprise a DH type field, which specifies the DH message (e.g., 0x01 for a master's public key or 0x02 for a slave's public key), a public length field specifying the length of the public key, and the public key, which can have a variable length.

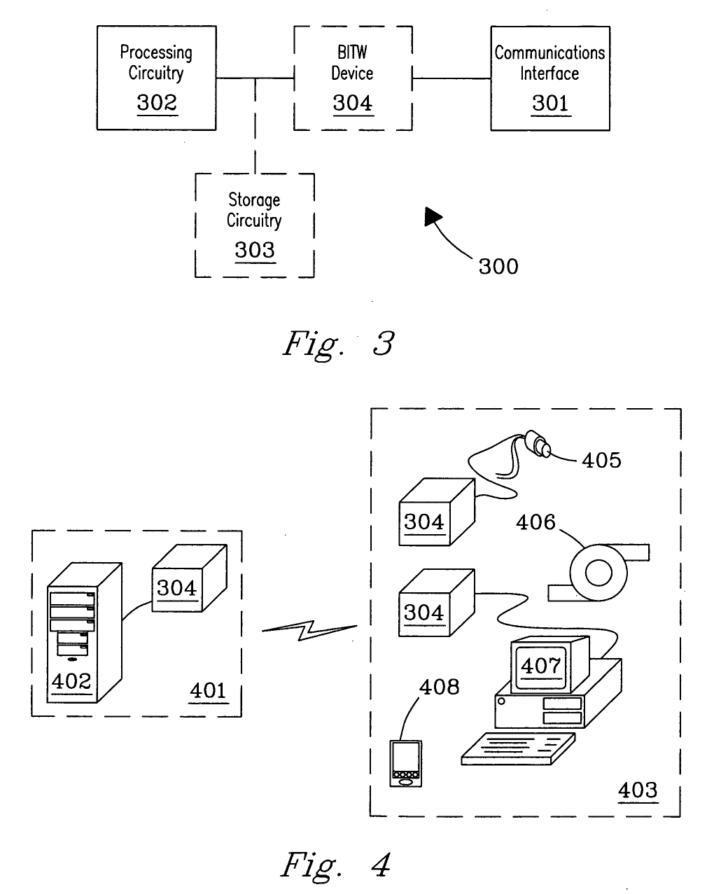

Referring to FIG. 3, the block diagram depicts aspects of an embodiment of an apparatus for authentication and validation of computer-processable communications. The apparatus 300 can represent one component of either a master or a slave device. A master device can refer to a control system, relative to other devices (e.g., slave devices). Typically, the master device comprises a computing apparatus such as a SCADA Master, I/O Server, Front End Processor, Operator Work Station, server, or handheld computing device. A slave device can refer, for example, to intelligent electric devices (IEDs), and can comprise computing apparatuses, RTUs, relays, programmable logic controllers, sensor devices, actuators, process equipment (e.g., pumps, valves, generators, electrical switches, etc.), door locks, weapon control devices, and hand held GPS units. As illustrated, the apparatus can include a communications interface 301, processing circuitry 302, and, depending on the implementation, storage circuitry 303 and/or a bump-in-the-wire (BITW) device 304.

The communications circuitry is arranged to implement communications of the apparatus with respect to other nodes (e.g., typically master to master, master to slave, and slave to master) and/or communications between apparatus 300 and any other associated component of the master and/or slave devices. For example, communications interface 301 can be arranged to facilitate the communication of information bidirectionally with respect to apparatus 300. In a more specific example, a slave device such as a pump can receive an computer-processable communication via the communications interface from a master device, such as a process control server, in the form of a command to activate. The communications interface can then facilitate communication of the activate command between the component of the slave device described by apparatus 300 and the other components, which, in the present example, compose the pump.

Communications interface 301 can be implemented as a network interface card, serial connection, parallel connection, USB port, SCSI host bus adapter, Firewire interface, wireless networking interface, PC card interface, PCI interface, IDE interface, SATA interface, or any other suitable arrangement for communicating with respect to apparatus 300. In an exemplary embodiment, a communications interface 301 can exist in each of a plurality of slave devices and in each of one or more master devices to facilitate computer-processable communications between the master and slave devices.

In one embodiment, processing circuitry 302 is arranged to execute computer-readable instructions, process data, calculate HMAC values, arrange communications according to frame structures described elsewhere herein, issue commands, and control other desired operations. Processing circuitry 302 can operate to encapsulate payloads, which are untrusted, with a header and an authenticator. Furthermore, it can operate to validate computer-processable communications that have been authenticated (e.g., encapsulated), perform key updates, apply traffic policies, process and execute health checks, and create and generate alerts. In some embodiments, processing circuitry can also control components of a master device and/or a slave device that are in addition to apparatus 300.

Processing circuitry 302 can comprise circuitry configured to implement desired programming provided by appropriate media in at least one embodiment. For example, the processing circuitry 302 can be implemented as one or more of a processor, and/or other structure, configured to execute computer-executable instructions including, but not limited to, software, middleware, and/or firmware instructions, and/or other hardware circuitry. Exemplary embodiments of processing circuitry 302 can include hardware logic, PGA, FPGA, ASIC, state machines, and/or other structures, alone or in combination with a processor. The examples of processing circuitry described herein are for illustration and other configurations are both possible and appropriate.

In some embodiments, apparatus 300 is implemented as an embedded solution, wherein the authentication and validation methods described herein are executed according to computer-readable instructions stored in and/or with apparatus 300. In such embodiments, apparatus 300 can further comprise storage circuitry 303.

The storage circuitry 303 can be configured to store programming such as executable code or instructions (e.g., software, middleware, and/or firmware), computer-processable data, databases, HMAC keys, computer-processable communication history logs, traffic policies, and/or other computer-processable information and can include, but is not limited to, processor-usable media. Exemplary programming can include, but is not limited to programming configured to cause apparatus 300 to encapsulate a payload with a header and an authenticator. In some embodiments, the programming can further cause processing circuitry 302 to transmit the encapsulated payload in a computer-processable communication, calculate HMAC values, and/or compare authenticator values received with an computer-processable communication with authenticator values recalculated according to the appropriate key.

Processor-usable media can include, but are not limited to any computer program product or article of manufacture that can contain, store, or maintain programming, data or computer-readable information for use by, or in connection with, an instruction execution system including the processing circuitry described elsewhere herein. Generally, exemplary processor-usable media can refer to electronic, magnetic, optical, electromagnetic, infrared, or semiconductor media. More specifically, examples of processor-usable media can include, but are not limited to, floppy diskettes, zip disks, hard drives, random access memory, read-only memory, flash memory, cache memory, compact discs, and digital versatile discs.

In embodiments wherein the authentication and validation methods described herein are not implemented as an embedded solution, apparatus 300 can further comprise a BITW device 304. The BITW apparatus can comprise a PC, workstation, industrial computer, or any other suitable processing device, especially as described elsewhere herein. The master or slave device, of which the BITW device is a component, can comprise its own processing circuitry or it can utilize the processing circuitry of the BITW device. Furthermore the use of a BITW device does not limit the other components that can compose the master or slave device. Accordingly, any suitable device can be made to communicate according to methods and protocols described elsewhere herein by operably connecting a BITW device.

Referring to FIG. 4, an embodiment of a system utilizing computer-processable communications that are authenticated and validated according to methods and apparatuses described elsewhere herein is depicted. In the instant embodiment, a master device 401 communicates bidirectionally with a plurality of slave devices 403. The master device 401 comprises a server having a BITW device 304 attached thereto. Typically, the BITW device 304 is operably connected between the communications interface and processing circuitry. The slave devices 403 include a sensor 405, a pump 406, a workstation 407, and a handheld PC 408. In the instant embodiment, the sensor 405 and the workstation 407 further comprise BITW devices 304 to facilitate authentication and validation of computer-processable communications. The pump 406 and the handheld PC 408 are depicted as utilizing embedded software solutions.

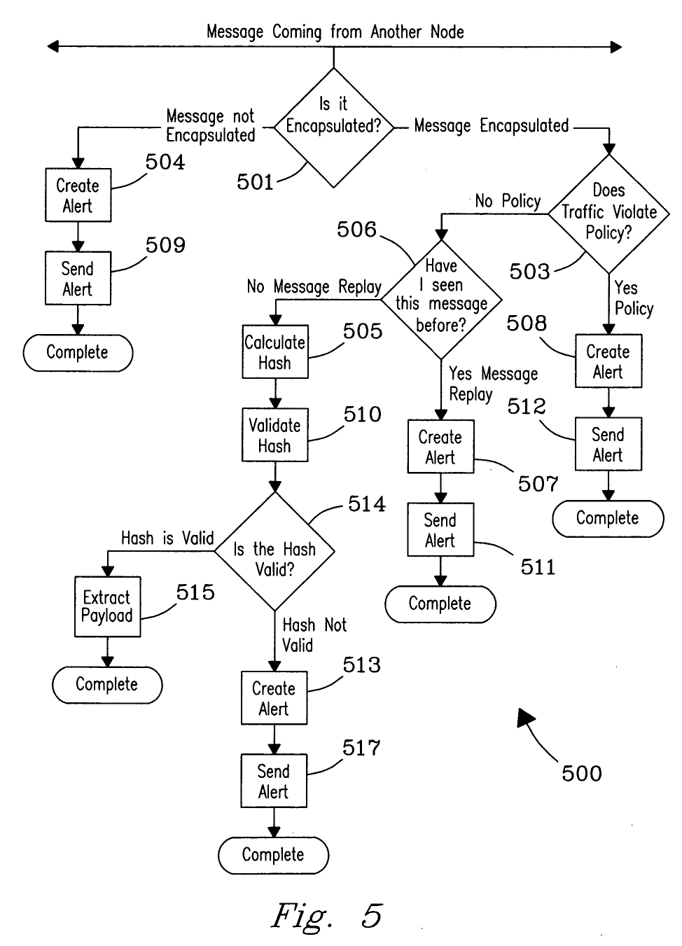

Referring to FIG. 5, the block diagram depicts an exemplary taxonomy of secure operations as it might be implemented consistent with the methods and apparatuses described elsewhere herein. As depicted, computer-processable communications arriving at a first node 500, for example, in the form of a message from a second node, are evaluated 501 to determine whether the message utilizes an appropriate frame structure, which, for example, can be based on the DNP3 protocol, and can be validated. If the message is not structured accordingly then an alert can be created 504 and sent 509.

In some embodiments, a table, or other suitable means, can be used to keep track of which communication channels are using authenticated communication protocols (e.g., those described herein). For example, since a master device can communicate with multiple remote sites, a table can be used to keep track of which remote sites are using authenticated communication. Accordingly, some embodiments of the present invention can support a mixture of authenticated and unauthenticated communication.

In various embodiments, alerts can be logged, sent to the sending node, prompt specific system responses (e.g., health check, resend command, etc.), and/or sent to an administrator via email, phone, instant message, text message, etc.

Messages that are authenticated can be further evaluated to ensure that they are consistent with traffic policies 503. Messages violating traffic policies can result in the creation 508 and transmission 512 of an alert. Messages that do not violate the traffic policies can be further evaluated to determine whether it has been received previously 506. For instance, the message can be compared to a message log that records the content of past messages. Since each message should have a unique ID and HMAC, if a message matches one that has been previously received, then it is likely that the message has been intercepted and replayed. An alert can be created 507 and sent 511 and alarms can be generated.

For messages that have not been replayed an HMAC value is calculated 505 based on the message header, the payload, and the device's unique key. The calculated authenticator is validated 510 against the authenticator value received with the message. If the authenticator is valid 514, then the payload content can be extracted 515. Otherwise, an alert can be created 513 and sent 517.

While a number of embodiments of the present invention have been shown and described, it will be apparent to those skilled in the art that many changes and modifications may be made without departing from the invention in its broader aspects. The appended claims, therefore, are intended to cover all such changes and modifications as they fall within the true spirit and scope of the invention.

We claim:

1. A computer-implemented method of authenticating and validating the source of a computer-processable communication comprising an untrusted payload, the method comprising:
encapsulating the payload with a header and an authenticator, wherein the header comprises a unique identifier and the authenticator comprises at least a portion of a keyed-hash message authentication (HMAC) value based on the content of the header, the content of the payload, and a unique key maintained for each of one or more receiving devices,

2. The method as recited in claim 1, wherein said encapsulating does not modify the content of the payload.

3. The method as recited in claim 1, further comprising:
transmitting the encapsulated computer-processable communications from a sending device to one or more receiving devices;
recalculating the authenticator according to the unique key maintained for each receiving device; and
comparing the original authenticator with the recalculated authenticator.

4. The method as recited in claim 1, wherein the computer-processable communication comprises serial communication.

5. The method as recited in claim 1, wherein the computer-processable communication comprises parallel communication.

6. The method as recited in claim 1, wherein the computer-processable communications occur at low bandwidth rates.

7. The method as recited in claim 6, wherein the low bandwidth rates are less than or equal to approximately 512 kbps.

8. The method as recited in claim 6, wherein the low bandwidth rates are less than or equal to approximately 115 kbps.

9. The method as recited in claim 1, wherein the computer-processable communications comprise real-time or near-real-time control system operations.

10. The method as recited in claim 1, wherein the computer-processable communication is implemented according to a protocol or environment selected from the group consisting of SCADA, control systems, process controls, DNS, NTP, VoIP, automated meter reading, streaming data, satellite communication, GPS, sensor networks, automated toll systems, SLIP, PPP, and instant messaging protocols.

11. The method as recited in claim 1, wherein the authenticator follows both the header and the payload in the frame structure of the computer-processable communication.

12. The method as recited in claim 1, wherein the unique identifier comprises a time and sequence number combination.

13. The method as recited in claim 1, wherein each unique identifier is associated with a single transmitted packet.

14. The method as recited in claim 1, wherein the payload comprises a key update when a payload type field specifies a key exchange communication.

15. A computer-readable medium having programming to control processing circuitry to configure computer-processable communications according to a frame structure, the frame structure comprising:
a. a payload comprising untrusted data;
b. a header comprising a unique identifier, wherein the header precedes the payload; and
c. an authenticator comprising at least a portion of an HMAC value based on the content of the header, the content of the payload, and a unique key maintained for each of one or more receiving devices,

16. The computer-readable medium as recited in claim 15, wherein the authenticator follows both the header and the payload in the frame structure.

17. The computer-readable medium as recited in claim 15, wherein the length of the authenticator is equal to the fewest bytes providing acceptable security for a given environment, protocol, or combination thereof.

18. The computer-readable medium as recited in claim 15, wherein the length of the authenticator is greater than or equal to approximately 12 bytes.

19. The computer-readable medium as recited in claim 15, wherein each unique identifier is associated with a single transmitted packet.

20. An apparatus comprising one or more master devices and one or more slave devices, each configured to communicate via computer-processable communications, wherein the computer-processable communications are arranged according to a frame structure comprising:
a. a payload comprising untrusted data;
b. a header comprising a unique identifier, wherein the header precedes the payload; and
c. an authenticator comprising at least a portion of an HMAC value based on the content of the header, the content of the payload, and a unique key maintained for each of one or more receiving devices.

21. The apparatus as recited in claim 20, wherein one or more of the master devices or slave devices comprise embedded programming to transmit and/or receive the computer-processable communications according to the frame structure.

22. The apparatus as recited in claim 20, wherein one or more of the master devices or slave devices further comprise a bump-in-the-wire (BITW) device configured to transmit and/or receive the computer-processable communications according to the frame structure, the BITW device operably connected between processing circuitry and a communications interface.

23. The apparatus as recited in claim 20, wherein the length of the authenticator is greater than or equal to approximately 12 bytes.
